(19) United States
(12) Patent Application Publication
(10) Pub. No.: US 2013/0157167 A1
(43) Pub. Date: Jun. 20, 2013

(54) ALTERNATE MATERIAL FOR ELECTRODE TOPCOAT

(71) Applicants: Scott L. Peters, Pittsford, NY (US); Amit Nayar, Pittsford, NY (US); Ruichun Jiang, Rochester, NY (US)

(72) Inventors: Scott L. Peters, Pittsford, NY (US); Amit Nayar, Pittsford, NY (US); Ruichun Jiang, Rochester, NY (US)

(73) Assignee: GM GLOBAL TECHNOLOGY OPERATIONS LLC, Detroit, MI (US)

(21) Appl. No.: 13/331,074

(22) Filed: Dec. 20, 2011

(51) Int. Cl. H01M 4/86; H01M 4/88; H01M 8/00; H01M 8/10

(52) U.S. Cl. 429/482; 429/523; 429/530; 429/535

(57) ABSTRACT

A reduced gas crossover fuel cell membrane and method of making. The fuel cell member includes an electrode layer with a catalyst and an electrochemically-active first ionomer and an overcoat layer disposed on the electrode layer. The overcoat layer is made of the same or different second ionomer relative to the first ionomer of the electrode layer with at least one reduced gas crossover characteristic.

### FIELD OF THE INVENTION

The present invention relates generally to fuel cells, and specifically to fuel cell electrodes having improved cell efficiency.

### BACKGROUND OF THE INVENTION

Fuel cells, also referred to as electrochemical conversion cells, produce electrical energy by processing reactants, for example, through the oxidation and reduction of hydrogen and oxygen. Hydrogen is a very attractive fuel because it is clean and it can be used to produce electricity efficiently in a fuel cell. The automotive industry has expended significant resources in the development of hydrogen fuel cells as a source of power for vehicles. Vehicles powered by hydrogen fuel cells would be more efficient and generate fewer emissions than today's vehicles employing internal combustion engines.

In a typical fuel cell system, hydrogen or a hydrogen-rich gas is supplied as a reactant through a flowpath to the anode side of a fuel cell while oxygen (such as in the form of atmospheric oxygen) is supplied as a reactant through a separate flowpath to the cathode side of the fuel cell. Catalysts, typically in the form of a noble metal such as platinum (Pt) or palladium (Pd), are placed at the anode and cathode to facilitate the electrochemical conversion of the reactants into electrons and positively charged ions (for the hydrogen) and negatively charged ions (for the oxygen). In one well-known fuel cell form, the anode and cathode may be made from a layer of electrically-conductive gaseous diffusion media (GDM) material onto which the catalysts are deposited to form a catalyst coated diffusion media (CCDM). An electrolyte layer (also known as an ionomer layer) separates the anode from the cathode to allow the selective passage of protons to pass from the anode to the cathode while simultaneously prohibiting the passage of reactant gases. The electrons generated by the catalytic reaction at the anode are also prohibited from flowing through the electrolyte layer, instead being forced to flow through an external electrically-conductive circuit (such as a load) to perform useful work before recombining with the charged ions at the cathode. The combination of the positively and negatively charged ions at the cathode results in the production of non-polluting water as a byproduct of the reaction. In another well-known fuel cell form, the anode and cathode may be formed directly on the electrolyte layer to form a layered structure known as a catalyst coated membrane (CCM). A membrane electrode assembly (MEA) may include, in one form, a CCM surrounded on opposing sides by respective anode and cathode GDMs, while in another form, a membrane made up of the electrolyte layer surrounded on opposing sides by respective anode and cathode CCDMs.

One type of fuel cell, called the proton exchange membrane (PEM) fuel cell, has shown particular promise for vehicular and related mobile applications. The electrolyte layer of a PEM fuel cell is in the form of a solid proton-transmissive electrolyte membrane (such as a perfluorosulfonic acid (PFSA) membrane, a commercial example of which is Nafion®). Regardless of whether either of the above CCM-based approach or CCDM-based approach is employed, the presence of an anode separated from a cathode by an electrolyte layer forms a single PEM fuel cell; many such single cells can be combined to form a fuel cell stack, increasing the power output thereof. Multiple stacks can be coupled together to further increase power output.

Simultaneously promoting proton transfer while reducing gas crossover is a problem for many such fuel cells. To achieve those competing goals, current electrode designs may additionally include an overcoat of PFSA ionomer deposited on the top of the electrode layers. Such an overcoat solution is typically a diluted ionomer solution (for example, at a 5 wt % solids concentration) with solvent, such as a water and alcohol mixture or organic solvent (for example, Dimethylacetamide (DMAC)). As an example, an overcoat loading of 0.16 mg/cm² (in its dry state) of solid PFSA ionomer translates into a 1 micron thick overcoat layer if it is coated on a nonporous substrate. Despite the presence of PFSA overcoats, adhesion, interfacial resistance and related problems persist.

### SUMMARY OF THE INVENTION

In accordance with the teachings of the present invention, a system and method of using a fuel cell electrode overcoat layer with an ionomer for exhibiting reduced gas crossover is disclosed.

In one embodiment, a fuel cell electrode may comprise a proton-conductive substrate and an electrode layer coupled to the substrate where the electrode layer may comprise a catalyst and an electrochemically-active first ionomer and an overcoat layer disposed on the electrode layer. The overcoat layer may comprise the same or different second ionomer relative to the first ionomer with at least one reduced gas crossover characteristic. Such an electrode may be configured to be a part of either a CCDM-based fuel cell or a CCM-based fuel cell.

In another embodiment, a membrane electrode assembly may comprise a proton-conductive membrane and a plurality of electrodes coupled to the membrane. Each of the plurality of electrodes may comprise an electrode layer comprising a catalyst and an electrochemically-active first ionomer and an overcoat layer disposed on the electrode layer. The overcoat layer may comprise the same or different second ionomer relative to the first ionomer with at least one reduced gas crossover characteristic.

In yet a further embodiment, a method of fabricating a fuel cell electrode may comprise placing an electrode layer comprising a catalyst and an electrochemically-active first ionomer coupled to a substrate and placing an overcoat layer disposed on the electrode layer. The overcoat layer may comprise the same or different second ionomer relative to the first ionomer with at least one reduced gas crossover characteristic.

### BRIEF DESCRIPTION OF THE DRAWINGS

FIG. 1A shows a schematic cross-section of one embodiment of a fuel cell with a free-standing PEM surrounded on opposing sides by CCDMs;

FIG. 1B shows a schematic cross-section of another embodiment of a fuel cell with a free-standing PEM in the form of a CCM;

FIG. 2 is a graph showing the gas (H₂O₂, N₂) permeability for different overcoat materials;

FIG. 3 is a graph showing measured H₂ crossover for fuel cell MEAs with different thicknesses and types of overcoat materials;

FIG. 4A shows the steps used to make a CCDM fuel cell electrode according to an aspect of the present disclosure; and

FIG. 4B shows the steps used to make a CCM fuel cell electrode according to an aspect of the present disclosure.

### DETAILED DESCRIPTION OF THE PREFERRED EMBODIMENTS

Illustrative embodiments of the present disclosure are described in terms of an electrode design which reduces gas (for example, H₂, O₂, N₂) crossover, improves cell efficiency and reduces cost. The electrode design includes a catalytically active base layer with an overcoat/topcoat layer on the surface of the electrode that is in contact with or on opposing sides of the PEM.

The inventors found that by using a different ionomer material for the electrode overcoat layers than the PFSA ionomer material as used in one or both of the electrode layers and membrane, the reactant gas crossover was reduced. The present inventors have discovered that one particular material, perfluorocyclobutane (PFCB), used as an overcoat/topcoat on the surface of the electrode layers has shown significant crossover reduction relative to traditional material. The inventors have also discovered that using the same ionomer material, for example, PFCB, in one or both of the electrode layers and membrane, as well as an overcoat/topcoat on the surface of the electrode layers has shown significant crossover reduction. Reduced gas crossover through the MEA may be achieved by applying the PFCB-based overcoat/topcoat on the electrode layer. Within the present context a different ionomer for the overcoat layers, the electrode layers and membrane is meant to include different chemical types of ionomer, for example, PFCB vs. PFSA, as well as an ionomer with the same chemical type of ionomer having different properties, for example, different equivalent weight (EW) or equivalent weights, or different ratio of elastomer, for example, PFCB+polyvinylidene fluoride (PVDF) blend. Therefore, depending on the overcoat layer thickness applied and the same or different ionomers used as an overcoat layer and in one or both the electrode layers and membrane, for example, PFCB+PVDF blend as an overcoat/topcoat on the surface of the electrode layers and PFSA in one or both the electrode layers and membrane, the gas crossover was reduced at least about 5%, or at least about 10%, or at least about 15%, or at least about 20%.

In one embodiment, the ionomer used for the overcoat layers is PFCB, and the ionomer in one or both the electrode layers and membrane is PFSA. Alternative ionomer materials used for the overcoat layers and one or both the electrode layers and membrane may include but are not limited to PFCB blended with a PVDF elastomer, sulfonated polyether ether ketone (SPEEK) and sulfonated poly p-phenylene (SParmax). This arrangement demonstrated reduced gas crossover and allowed the cost of the electrode to be reduced because PFCB has about 30% lower cost relative to PFSA. Alternatively, a thicker PFCB overcoat layer may be used to reduce the gas crossover even more while maintaining the same cost for materials. Suitable PFCB ionomers are described in U.S. application Ser. Nos. 12/549,881, 12/549,885, and 12/549,904, each of which is owned by the assignee of the present disclosure and incorporated herein by reference.

In a further embodiment, the same ionomer material, PFCB blended with a PVDF elastomer, was used for the overcoat layers and in one or both the electrode layers and membrane. Alternative ionomer materials used for the overcoat layers and in one or both the electrode layers and membrane may include but are not limited to PFCB, SPEEK and SParmax. This arrangement demonstrated an even more reduced gas crossover.

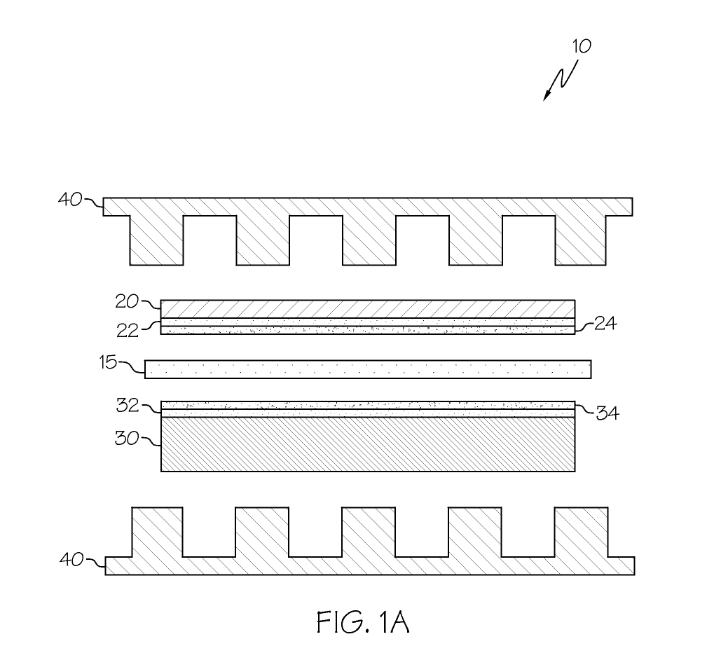

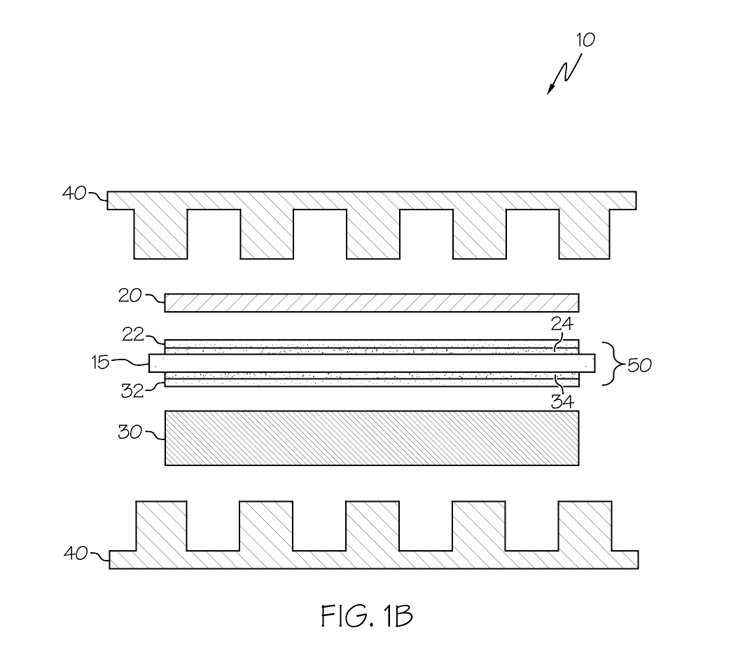

In one form of manufacture, the electrode is prepared as electrode ink before being formed into a CCDM or CCM configured structure such as shown in FIGS. 1A and 1B respectively. An electrode ink typically contains ionomer, organic solvents such as isopropyl alcohol, ethanol, or the like and electrocatalyst. Additional materials can be incorporated into the electrode ink to increase robustness or other indicia of electrode performance. For example, ionic conducting components can be incorporated into the electrode ink, if desired. Likewise, hydrophobic particles, for example, PTFE, can be incorporated into the electrode ink to tailor the electrode water management capability, if desired. Graphitized or amorphous carbon powder or fiber, other durable particles, or other electrocatalysts like Pt supported on carbon can also be incorporated into the electrode ink to increase the electrode water storage capacity, if desired.

Referring FIGS. 1A and 1B, partial, sectional views of a PEM fuel cell 10 in exploded form show respectively a CCDM-based configuration and a CCM-based configuration. In either case, the fuel cell 10 includes a substantially planar PEM 15 and diffusion layers (GDM) 20 (for the anode) and 30 (for the cathode), which include an overcoat layer (labeled individually as overcoat layer 24 and overcoat layer 34) and a respective pair of catalyst layers 22 (for the anode) and 32 (for the cathode) arranged in facing contact with respective overcoat layers 24, 34. Bipolar plates 40 are provided with numerous channels to permit reactant gases to reach the appropriate side of the overcoat layers 24, 34, as well as the PEM 15 through the diffusion layers 20, 30.

The diffusion layers 20, 30 provide electrical contact between the respective catalyst layers 22, 32 and the bipolar plates 40 that may additionally act as current collectors. Each of the diffusion layers 20, 30 may be made to define a generally porous construction to facilitate the passage of gaseous reactants to the catalyst layers 22, 32. Suitable materials for the diffusion layers 20, 30 may include, but are not limited to, carbon paper, porous graphite, felts, cloths, mesh or other woven or non-woven materials that include some degree of porosity. The thicker cathode diffusion layer 30 relative to the anode diffusion layer 20 makes for a longer, and hence difficult water vapor path, thereby helping to maintain PEM 15 in a sufficiently hydrated state. Nevertheless, it will be appreciated by those skilled in the art that such differences in thickness are not necessary to the operation of fuel cell 10, and may instead be of substantially comparable thickness.

In the CCDM-based configuration of FIG. 1A, each diffusion layers 20, 30 acts as the aforementioned GDM or gaseous diffusion layer (GDL) that can be used as a substrate for the catalyst layers 22, 32 that may be deposited in, for example, ink form with the overcoat layers 24, 34 arranged in facing contact with the catalyst layers 22, 32. In the CCM-based configuration of FIG. 1B, the PEM 15, overcoat layers 24, 34 and catalyst layers 22, 32 collectively define the CCM 50. In either the CCDM-based configuration or the CCM-based configuration, the overcoat layers 24, 34 arranged in facing contact with the catalyst layers 22, 32 can be attached, deposited, embedded or otherwise joined to their respective diffusion layers 20, 30. As will be appreciated by those skilled in the art, regardless of whether the configuration includes the CCDM-based overcoat layers 24, 34 arranged in facing contact with the anode and cathode catalyst layers 22, 32 attached to the respective diffusion layers 20, 30, or whether the configuration includes the CCM-based the overcoat layers 24, 34 arranged in facing contact with the anode and cathode catalyst layers 22, 32 attached to the PEM 15 as part of CCM 50, the free-standing nature of the underlying PEM 15 remains the same.

In the CCDM-based configuration, the catalyst layers 22, 32 are coupled to the diffusion layers 20, 30 directly. Overcoat layers 24, 34 are disposed on the catalyst layers 22, 32, while the free standing PEM 15 is located between the overcoat layers 24, 34. The diffusion layers 20, 30 and catalyst layers 22, 32 containing the overcoat layers 24, 34 may be hot pressed to the PEM 15 with a subgasket around the perimeter. As stated above, the overcoat layers 24, 34 may consist of but are not limited to PFCB, PFCB with a PVDF blend, SPEEK or SParmax located between the catalyst layers 22, 32 and the PEM 15. Alternatively, the electrode layers, respectively, catalyst layers 22, 32 located between the overcoat layers 24, 34 and the diffusion layers 20, 30 may consist of but are not limited to PFCB, PFCB with a PVDF blend, SPEEK or SParmax.

Referring to FIG. 1B, in a CCM-based configuration, the overcoat layers are disposed on the catalyst layers 22, 32. The PEM 15 is hot pressed onto the overcoat layers 24, 34 creating the free standing CCM 50. Leaving the diffusion layers 20, 30 above and below the free standing CCM 50. The catalyst layers 22, 32 may be coated onto a decal substrate which is later transferred to the PEM 15. The decal substrate may be removed after the overcoat layers 24, 34 are disposed on the catalyst layers 22, 32. The decal substrate should be chemically stable, flat, and smooth. The decal substrate can be a porous material or a nonporous material. Suitable decal substrates include, but are not limited to, ethylene tetrafluoroethylene (ETFE), expanded polytetrafluoroethylene (ePTFE), or polyimide film. As with the CCDM-based configuration discussed above, the overcoat layers 24, 34 may consist of but are not limited to PFCB, PFCB with a PVDF blend, SPEEK or SParmax. Alternatively, the electrode layers, respectively, catalyst layers 22, 32 may consist of but are not limited to PFCB, PFCB with a PVDF blend, SPEEK or SParmax. The catalyst layers 22, 32 containing the overcoat layers 24, 34 are then transferred to the PEM 15. The location of the overcoat layers 24, 34 is between the catalyst layers 22, 32 and the PEM 15 as part of CCM 50.

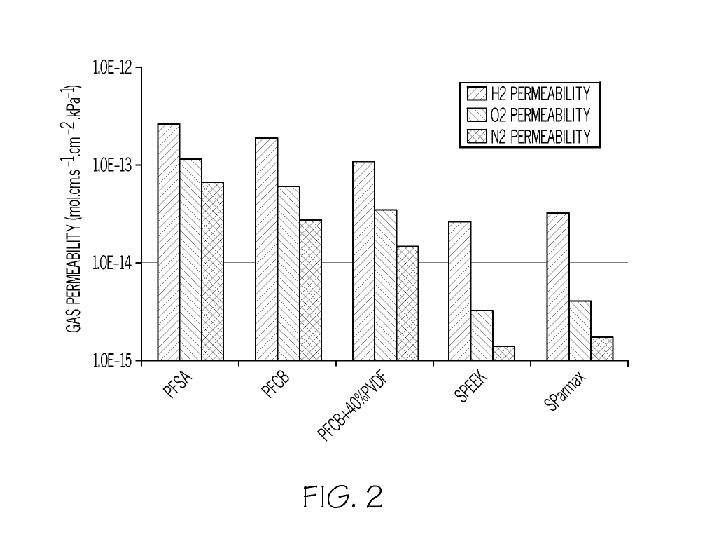

FIG. 2 is a graph showing the gas (for example, H₂O₂, and N₂) permeability for different overcoat materials. Gas permeability is a fundamental property of materials, which is independent of thickness. For example, PFCB+40% PVDF shows lower gas permeability than PFCB only, which itself shows lower gas permeability than PFSA. The gas permeability was measured using a gas chromatography (GC) system. Likewise, lower gas permeability associated with the use of one or more of PFCB, PFCB+PVDF blend, SPEEK and SParmax helps reduce gas crossover in fuel cell operation, as shown. It will be appreciated by those skilled in the art that other blends of the materials described above are possible in order to help reduce gas crossover in fuel cell operation.

The following is an example wherein electrodes were made using the above-mentioned CCDM-based configuration. Electrode ink containing electrocatalysts, PFSA ionomer, water and alcohol mixtures were coated on diffusion layers 20, 30 to produce catalyst layers 22, 32. The catalyst layers 22, 32 were then overcoated with a solution which included a PFCB-based ionomer in a water and alcohol solvent mixture, or organic solvent, for example, DMAC. The overcoat layers 24, 34 were 2 μm or 4 μm thick layers of a PFCB. For comparison purposes, a 2 μm thick overcoat with a reference solution that included PFSA as the ionomer was also prepared.

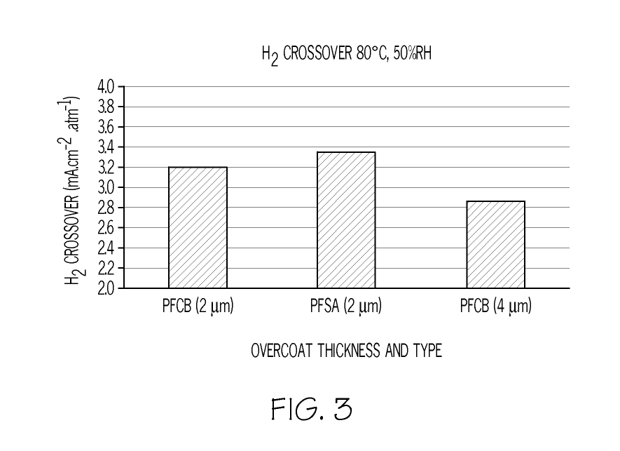

FIG. 3 shows the measured H₂ crossover (mA.cm⁻²/atm) for fuel cell MEAs with 2 μm thick layers of PFCB (1 μm on anode and 1 μm on cathode), 2 μm thick layers of PFSA (1 μm on anode and 1 μm on cathode) and 4 μm thick layers of PFCB (2 μm on anode and 2 μm on cathode), respectively. H₂ crossover was measured using the limiting current method. Humidified H₂ is fed to the cathode, while humidified N₂ is supplied to the anode side of the cell. The voltage across the cell is imposed by the Gamry board. The H₂ crossover rate is measured at various temperatures and relative humidity conditions. In all the tests, the H₂ partial pressure is kept at 200 kPa by adjusting the total pressure according to the H₂O partial pressure at given temperature and RH (pH₂=constant=Pcell−pH₂O). The voltage imposed across the cell by the Gamry board was set up from 0.4 V to 0.7 V with 0.05 V intervals and 5 minutes at each voltage value. At such a range of voltage values, the measured current is limited by the H₂ crossover rate at each given condition. The underlying principle of this test is shown below:

Anode: H₂→2H++2e− (1)

Cathode: 2H++2e−→H₂ (2)

The 2 μm thick layer of PFCB showed a 5% improvement in reducing H₂ crossover compared to the 2 μm thick layer of PFSA, while the 4 μm thick layer of PFCB showed a 19% improvement over the 2 μm thick layer of PFSA.

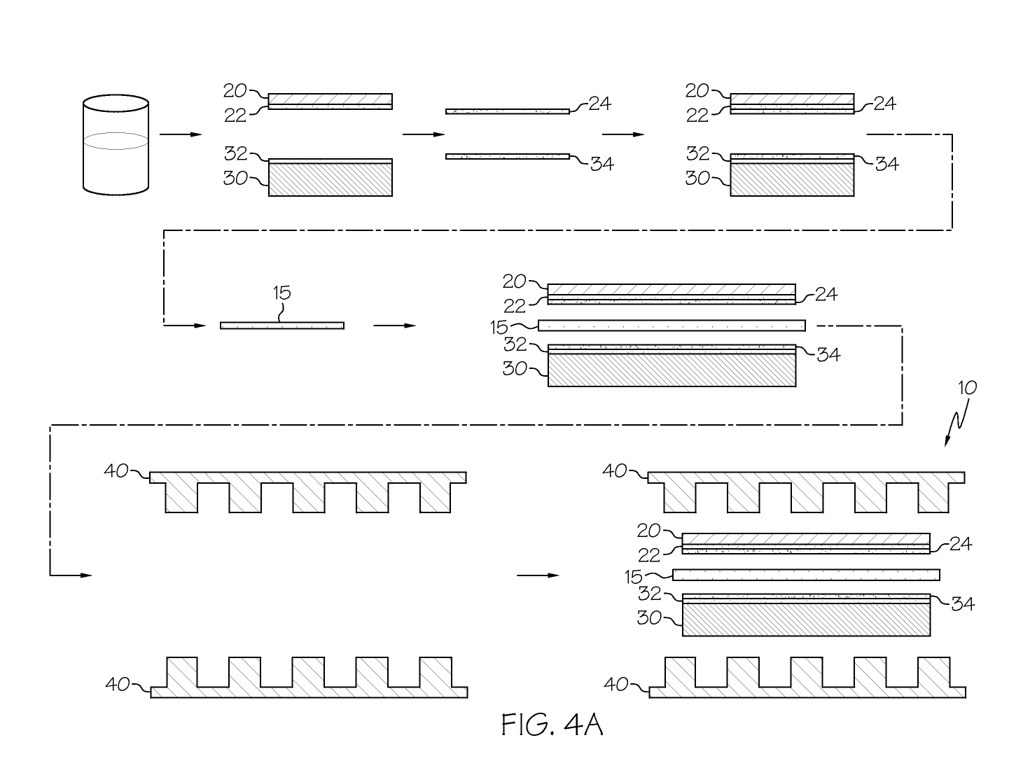

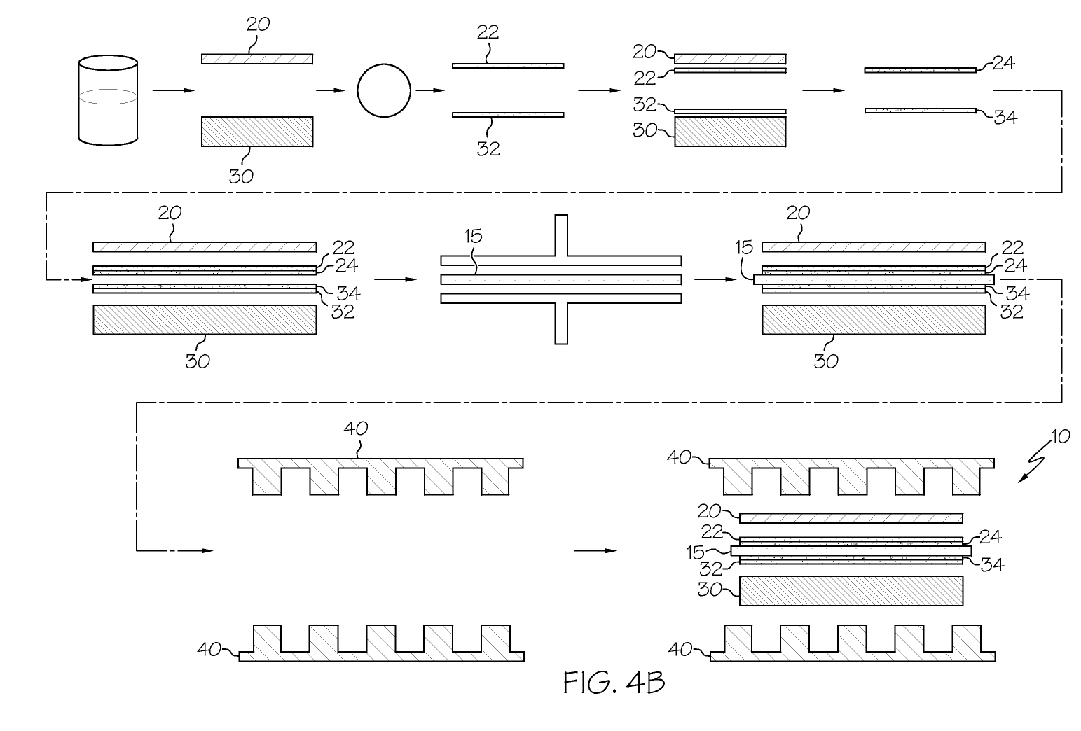

FIG. 4A illustrates a procedure for constructing a CCDM fuel cell electrode with an overcoat layer for reducing gas crossover. In the first part of the procedure, an electrode ink is coated to the diffusion layers 20, 30 to produce catalyst layers 22, 32. The overcoat layers 24, 34 are disposed to the catalyst layers 22, 32. The free standing PEM 15 is located between the overcoat layers 24, 34. Bipolar plates 40 are provided between the diffusion layers 20, 30 with numerous channels to permit reactant gases to reach through the diffusion layers 20, 30, catalyst layers 22, 32 and overcoat layers 24, 34, as well as the PEM 15.

FIG. 4B illustrates a procedure for constructing a CCM fuel cell electrode with an overcoat layer for reducing gas crossover. In the first part of the procedure, an electrode ink is coupled to the diffusion layers 20, 30. A film/decal substrate is coupled to the catalyst layers 22, 32. The overcoat layers 24, 34 are disposed to the catalyst layers 22, 32. The PEM 15 is hot pressed onto the overcoat layers 24, 34 and catalyst layers 22, 32 creating the free standing CCM 50. Leaving the diffusion layers 20, 30 above and below the free standing CCM 50. Bipolar plates 40 are provided between the diffusion layers 20, 30 with numerous channels to permit reactant gases to reach through the diffusion layers 20, 30 and the CCM 50.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A fuel cell electrode comprising:
a proton-conductive substrate;
an electrode layer coupled to said substrate, said electrode layer comprising a catalyst and an electrochemically-active first ionomer; and
an overcoat layer disposed on said electrode layer, said overcoat layer comprising a second ionomer with at least one reduced gas crossover characteristic relative to said first ionomer.

2. The fuel cell electrode of claim 1, wherein said first ionomer comprises perfluorosulfonic acid and said second ionomer comprises perfluorocyclobutane.

3. The fuel cell electrode of claim 1, wherein said second ionomer comprises perfluorocyclobutane.

4. The fuel cell electrode of claim 3, wherein said second ionomer further comprises polyvinylidene fluoride.

5. The fuel cell electrode of claim 1, wherein said second ionomer comprises sulfonated polyether ether ketone.

6. The fuel cell electrode of claim 1, wherein said second ionomer comprises sulfonated poly p-phenylene.

7. The fuel cell electrode of claim 1, wherein said proton-conductive substrate comprises a proton-conductive membrane.

8. The fuel cell electrode of claim 1, wherein said first ionomer and said second ionomer comprises the same material.

9. A membrane electrode assembly comprising:
a proton-conductive membrane; and
a plurality of electrodes coupled to said membrane, each of said plurality of electrodes comprising:
an electrode layer comprising a catalyst and an electrochemically-active first ionomer; and
an overcoat layer disposed on said electrode layer, said overcoat layer comprising a second ionomer with at least one reduced gas crossover characteristic relative to said first ionomer.

10. The membrane electrode assembly of claim 9, wherein said first ionomer comprises perfluorosulfonic acid and said second ionomer comprises perfluorocyclobutane.

11. The membrane electrode assembly of claim 9, wherein said second ionomer comprises perfluorocyclobutane.

12. The membrane electrode assembly of claim 11, wherein said second ionomer further comprises polyvinylidene fluoride.

13. The membrane electrode assembly of claim 9, wherein said second ionomer comprises sulfonated polyether ether ketone.

14. The membrane electrode assembly of claim 9, wherein said second ionomer comprises sulfonated poly p-phenylene.

15. The membrane electrode assembly of claim 9, wherein said first ionomer and said second ionomer comprises the same material.

16. The membrane electrode assembly of claim 9, wherein at least one of said plurality of electrodes further comprises a proton-conductive substrate to which at least one of said electrode layer and said overcoat layer are coupled.

17. A method of fabricating a fuel cell electrode comprising:
coupling an electrode layer comprising a catalyst and an electrochemically-active first ionomer to a substrate; and
placing an overcoat layer disposed on said electrode layer, said overcoat layer comprising a second ionomer with at least one reduced gas crossover characteristic relative to said first ionomer.

18. The method of claim 17, wherein said first ionomer comprises perfluorosulfonic acid and said second ionomer comprises perfluorocyclobutane.

19. The method of claim 17, wherein said second ionomer comprises perfluorocyclobutane.

20. The method of claim 19, wherein said second ionomer further comprises polyvinylidene fluoride.

21. The method of claim 17, wherein said second ionomer comprises sulfonated polyether ether ketone.

22. The method of claim 17, wherein said second ionomer comprises sulfonated poly p-phenylene.

23. The method of claim 17, wherein said first ionomer and said second ionomer comprises the same material.

24. The method of claim 17, wherein said substrate is a diffusion media.

25. The method of claim 17, wherein said substrate is a proton conductive membrane.

26. The method of claim 17, further comprising hot pressing said overcoat layer disposed adjacent said electrode layer to a membrane to form a membrane electrode assembly, said membrane comprising said first ionomer and said overcoat layer comprising said second ionomer.

27. The method of claim 17, wherein said substrate is a decal substrate, and further comprising removing said decal substrate after said overcoat layer disposed adjacent said electrode layer is hot pressed to said membrane.
